(19) United States
(12) Patent Application Publication
(10) Pub. No.: US 2004/0164539 A1
(43) Pub. Date: Aug. 26, 2004

(54) Mud flap lifter system

(76) Inventor: Donald Yancey Bernard, Cincinnati, OH (US)

Correspondence Address: J. Dwight Poffenberger, Jr., Wood, Herron & Evans, L.L.P., 2700 Carew Tower, 441 Vine Street, Cincinnati, OH, 45202-2917, US

(21) Appl. No.: 10/374,926

(22) Filed: Feb. 25, 2003

(51) Int. Cl. B62B 9/14

(52) U.S. Cl. 280/848

(57) ABSTRACT

A mud flap lifter system is provided for mounting on a truck or other vehicle in which the system lifts the mud flap away from the tires. The mud flaps are connected to a rod rotatable or pivotable about a central axis. Activation of a driver is used to rotate the rod and therefore lift the mud flaps. The driver may be manually or automatically activated. The system may be actuated automatically when the vehicle is put into reverse.

### FIELD OF THE INVENTION

This invention relates generally to movable mud flaps for use on vehicles and, more specifically, to a mud flap lifter system that raises the mud flaps to prevent damage to the mud flaps during normal vehicle operation.

### BACKGROUND OF THE INVENTION

Mud flaps are widely used on construction and excavation vehicles and trailers to prevent water, mud, rocks, and other road debris from being sprayed or projected from behind the vehicle or trailer. A common problem for larger, heavier vehicles is the amount of water sprayed from around the rear tires when these vehicles are operating in a wet environment, such as a wet road. Other vehicles behind or in close proximity to one of these large trucks or trailers get sprayed with water shooting off the rotating tires. The water spraying from behind these vehicles is often dirty, making visibility for trailing vehicles extremely difficult. This situation is a nuisance to travelers and more importantly, poses a potential danger.

Furthermore, vehicles such as dump trucks often work in wet, muddy environments or environments having a significant amount of road debris, such as gravel. Due to the weight of these trucks, it is common for mud and gravel to become lodged in the tread of the truck tires. When these trucks get on the roads and start operating at increased rates of speed, the mud and/or gravel become dislodged from the tire tread and shoot out from behind the truck, sometimes at extremely high velocities. It is not uncommon for a trailing vehicle to have its paint chipped or its windshield cracked from projectiles shooting out from behind a dump truck or similar vehicle.

For these reasons, dump trucks and other construction vehicles are fitted with mud flaps that are typically mounted directly behind the rear tires. Mud flaps reduce the amount of water sprayed behind a moving truck, as well as rocks and other debris thrown from the rotating tires, and thereby reduce the potential danger posed by these projectiles. A majority of states have statutes or regulations that require trucks and trailers to have mud flaps. These statutes or regulations dictate the size of the mud flap, the distance from the mud flap to the ground, and the distance from the mud flap to the tire. Truck operators that fail to meet these laws are subject to fines and other penalties.

A common problem for vehicles that have mud flaps is that the mud flaps are often torn off when the vehicle is in reverse motion or dumping a load. When a truck is backing up over rough terrain, the mud flap may contact an object behind the truck. The mud flap is then brought into contact with the tire. As the truck backs up further, the mud flap gets caught under the tire and is torn from the truck.

Additionally, mud flaps may be torn away when trucks encounter soft terrain. Many work sites have loose or wet dirt such that when a heavy truck is run over the ground, the truck sinks several inches. When this occurs, the mud flap contacts the ground and similarly gets caught under the tires as the truck reverses. The mud flap is consequently torn from the truck. Further, when a dump truck dumps a load of material, some of the material may land on top of the mud flap. This would be especially true when the truck has sunk into the ground and the bottom of the mud flap rests on the ground. As the truck pulls away or the bed is lowered, the weight of the material on top of the mud flap prevents the mud flap from moving with the vehicle, and thus, tears the mud flap away from the truck.

Mud flaps that are torn away from a truck frustrate truck owners, operators and trailing vehicles and may become prohibitively expensive to repair. Many truck operators are often unaware that a mud flap has been torn from the truck. When these trucks get on the highway, they violate state and/or federal laws and are fined—fines often being doubled, tripled, etc. for repeat offenders. If truck operators know that a mud flap has been torn from the truck at a particular work site, they are faced with deciding whether to fix the mud flat, which entails significant costs due to lost operational time and manpower expense, or risk getting fined by breaking state and/or federal law.

There have been a number of mud flap devices and designs proposed that address this problem by raising, folding or retracting the mud flap while the truck is in reverse or is unloading material. One such proposal is to raise the lower portion of the mud flap and essentially fold the mud flap in half. For example, U.S. Pat. No. 3,582,109 discloses a mud flap system utilizing a cable attached to the bottom outside portion of the mud flap. A power cylinder attached to the truck and further attached to one end of the cable is actuated causing the cable to be drawn in. As a result, the bottom of the mud flap is lifted upward and away from the truck tires, essentially folding the mud flap in half. Similarly U.S. Pat. No. 6,158,775 discloses mud flap lifting system which is pneumatically operated.

These systems and other similar devices, however, have several disadvantages. These devices are generally complex, require sufficient underbody to attach a power cylinder and leave components unprotected from the environment. For instance, the cable may rust or otherwise become damaged due to weather, or may come in direct contact with obstacles at the rear of the truck. Furthermore, the point where the cable is attached to the bottom of the mud flap is weakened and therefore prone to cracking and other damage. Finally, a cable system requires that a mud flap be modified to receive the cable attachment. This increases the cost of installation and increases the cost of mud flap replacement.

Other mud flap systems are used to retract mud flaps, as shown in U.S. Pat. Nos. 2,721,760, 2,857,200, and 5,582,431. Rather than folding the mud flaps, as in the previously described systems, the mud flaps are retracted into an enclosure near the top of the mud flap. These systems use a series of cables and springs that are not practical to the truck operator. Retractable systems are also very expensive and often become jammed with mud or other debris inside the enclosure, thus preventing proper operation.

Therefore, there is a need for an economical, practical and reliable mud flap lifter system that overcomes the disadvantages of the previous designs and effectively prevents mud flaps from being torn off upon backing up or dumping a load of material.

### SUMMARY OF THE INVENTION

According to the present invention, a mud flap lifter system is provided which is incorporated into a truck or other similar vehicle.

The mud flap lifter system includes mud flaps, a pivotable or rotatable rod rotatable about a central axis, a drive assembly including a drive shaft and a driver, i.e. means for rotating the pivotable rod through the drive shaft. The mud flaps are attached to a mud flap assembly such that, when the rod is rotated, the mud flap assembly rotates simultaneously, rolling up the mud flaps and lifting them above the ground from their initial position. The mud flaps are then prevented from coming into contact with the tires when the vehicle is put into reverse, and thus, are prevented from being ripped off the vehicle or otherwise damaged.

The rod is rotated by a drive assembly including a driver and a drive shaft operatively coupled to the rod. The driver may be a pneumatic cylinder, a hydraulic cylinder, hand crank or any other device. Activation of the driver, either manually or automatically, causes the driver to move the drive shaft forwardly, thereby causing rotation of the rod. The vehicle may be electrically wired such that upon putting the vehicle in reverse, the driver is automatically actuated to pull the drive shaft forwardly, thereby rotating the rod and and lifting the mud flaps.

### BRIEF DESCRIPTION OF THE DRAWINGS

FIG. 1 is a perspective view of a preferred embodiment of the mud flap lifting device of the present invention.

FIG. 2 is a fragmentary side elevational view of the mud flap lifting device of FIG. 1 with the mud flaps in a lowered position.

FIG. 3 is a fragmentary side elevational view of the mud flap lifting device of FIG. 1 with the mud flaps in a raised position.

FIG. 4 is a perspective view of an alternative embodiment of the mud flap lifting device of the present invention.

FIG. 5 is a side elevational view of the mud flap lifting device of FIG. 4 with the mud flaps in a lowered position.

FIG. 6 is a side elevational view of the mud flap lifting device of FIG. 4 with the mud flaps in a raised position.

FIG. 7 is a top plan view of an alternative embodiment of a mud flap lifting device of the present invention.

FIG. 8 is a cross-sectional view taken along the line 8-8 of FIG. 9.

FIG. 9 is an enlarged partial perspective view of a portion of the mud flap lifting device of FIG. 1.

### DETAILED DESCRIPTION OF THE DRAWINGS

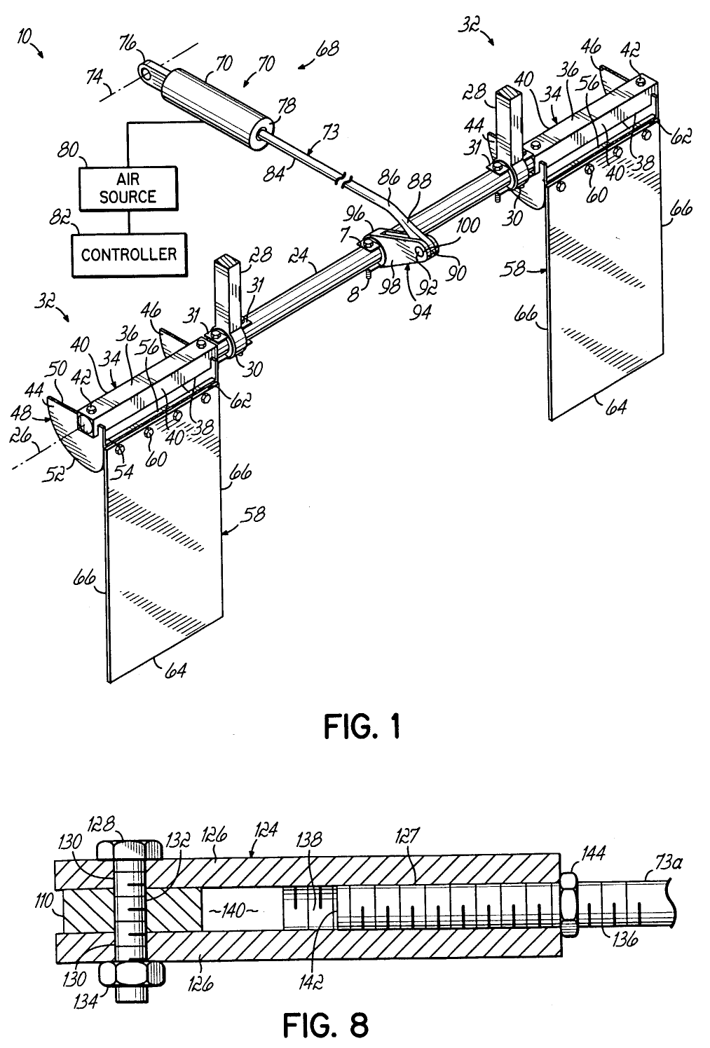

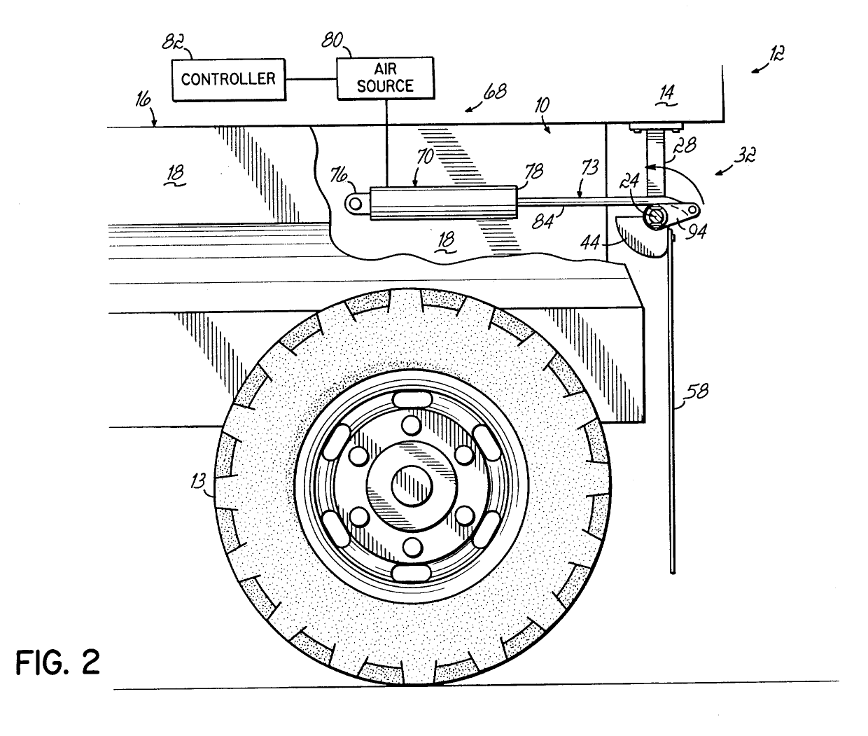

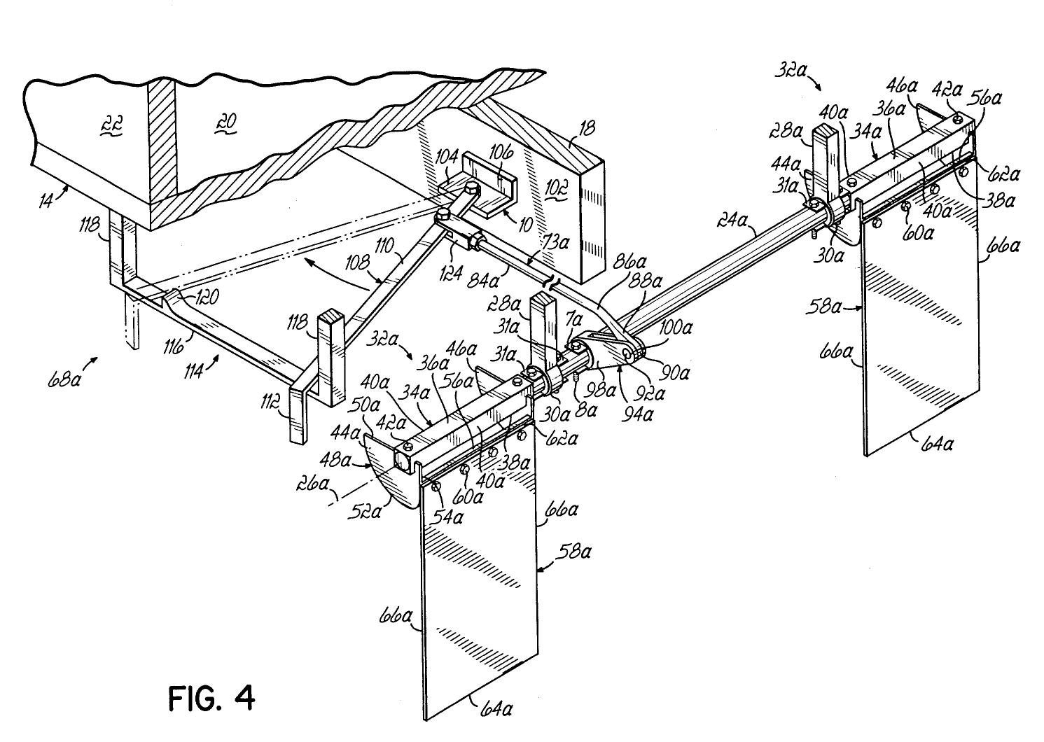

Referring to the drawings and particularly to FIG. 1, a preferred embodiment of the mud flap lifter system 10 is illustrated. As illustrated in FIGS. 2-3 and 7, the mud flap lifter system 10 is incorporated into a truck 12 having wheels 13, a rectangular bed 14 supported by a frame 16 comprising two vertically oriented beams 18, as is conventional. As best illustrated in FIG. 4, the bed 14 has a bottom 20 and two side walls 22 extending upwardly from the bottom 20. While the present invention will be particularly described as mounted on a truck for use in construction, it is understood that other vehicles are contemplated, such as excavation vehicles and tractor trailers.

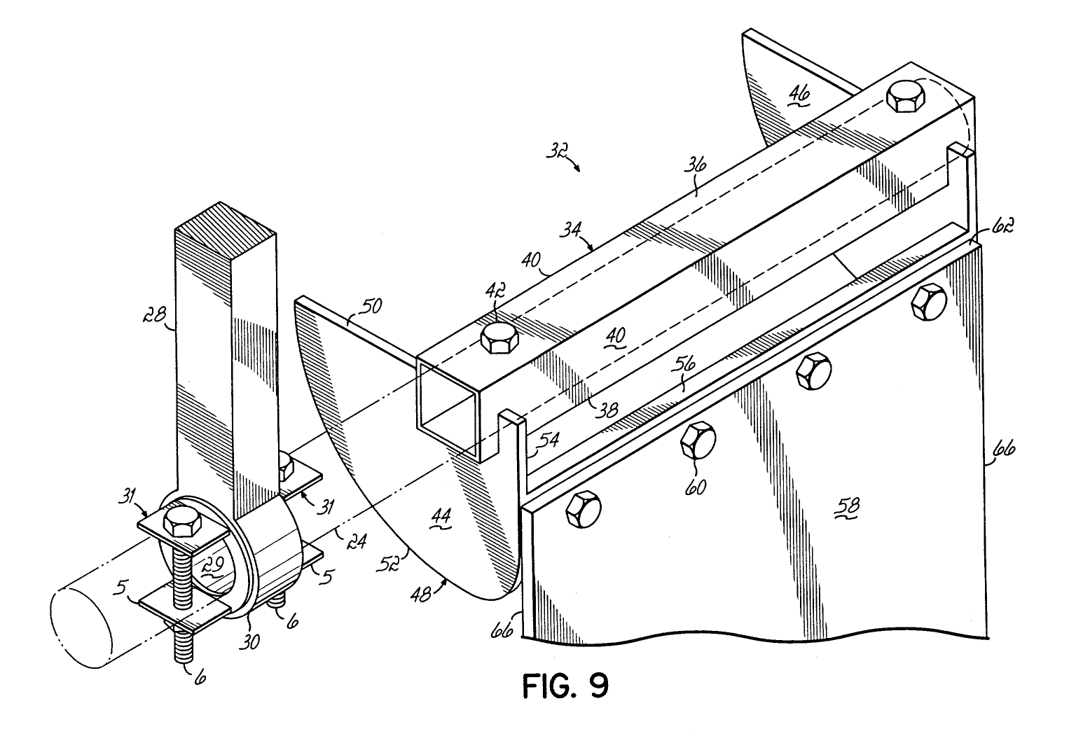

As best illustrated in FIG. 1, the mud flap lifter system 10 includes a rotatable rod 24 having a generally circular cross-sectional configuration. The rod 24 is rotatable and pivotable about a central axis 26. The rod 24 is supported below the bed 14 of the truck 12 by a pair of supports 28, the lower ends of which have end portions 30 which surround the rod 24. Bearings 29 may be placed inside the end portions 30 of the supports 28. As illustrated in FIG. 9, each support 28 is prevented from lateral movement along the length of the rod 24 by stabilizers 31, each one of which comprises a pair of plates 5 and a bolt 6 therethrough.

A pair of mud flap assemblies 32 are secured to opposite ends of the rotatable rod 24. Each mud flap assembly 32 comprises a sleeve 34 adapted to fit around the rotatable rod 24. The sleeve 34 has a generally rectangular cross section, as best illustrated in FIG. 1. The sleeve 34 has a top wall 36, a bottom wall 38 and a pair of side walls 40. The sleeve 34 is secured to the rotatable rod 24 with bolts 42, as shown in FIG. 1 so that when the rod 24 rotates the sleeve 34 rotates. Any other fastener or means to connect the rod 24 and sleeve 34 so they rotate simulataneously may be used in accordance with the present invention.

A first end plate 44 and a second end plate 46 are welded or otherwise secured to the sleeve 34 and comprise part of the mud flap assembly. As best illustrated in FIG. 1, the first and second end plates 44, 46 are spaced from each other a distance approximately equal to the length of the sleeve 34. The first and second end plates 44, 46 are identically configured, although for purposes of the present invention they may differ from one another. Each end plate 44,46 has a perimeter or outer edge 48 including a first linear portion 50, an arcuate or curved portion 52 generally in the shape of a quarter circle and a second linear portion 54. A flange 56 extends between the first and second end plates 44,46 and more particularly between the second linear portions 54 of the perimeters 48 of the first and second end plates 44,46. The flange 56 is generally rectangular and generally planar; however other configurations may be used without departing from the spirit of the present invention.

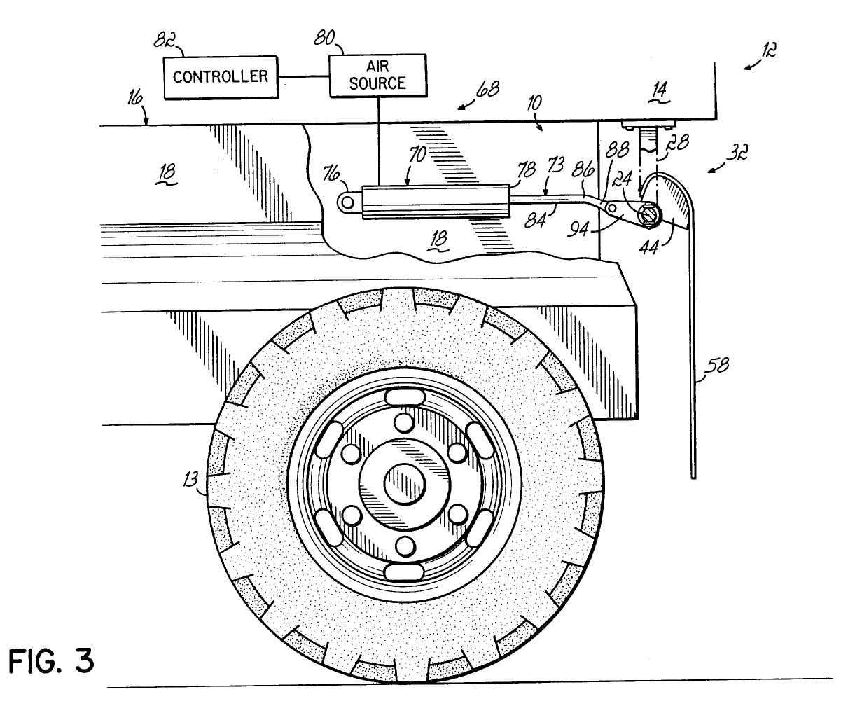

Also forming part of each mud flap assembly 32 is a mud flap 58 which is secured to the flange 56 with fasteners 60. Other methods of securing the mud flap 58 to the flange 56 may be used. As is conventional, each mud flap 58 is generally rectangular having an upper edge 62, a lower edge 64 and side edges 66. When the mud flap assembly 32 is rotated by rotation of the rod 24 in a manner described below, the mud flaps 58 move from a lowered position illustrated in FIG. 2 to a raised position illustrated in FIG. 3.

As shown in FIG. 1, a drive assembly 68 is used to power the mud flap lifter system. The drive assembly 68 in this embodiment includes a driver 70 which in the preferred embodiment illustrated in FIGS. 1-3 is a pneumatic cylinder 72 centrally mounted to rotate about a horizontal axis 74. The pneumatic cylinder 72 has a first end 76 coupling the cylinder 72 to the vehicle and a second end 78. A drive shaft 73 extends rearwardly from the second end 78 of the pneumatic cylinder 72. The drive shaft 73 has a linear front portion 84, a bend 86 and a linear rear portion 88. The rear portion 88 has an end portion 90 with a hole therethrough adapted to receive a pin 92.

The drive assembly 68 and more specifically, the drive shaft 73 is operatively coupled to the rod 24 via a collar 94 mounted on the rod 24 approximately at the mid-point of the length of the rod 24. The collar 94 has a central portion 96 with a hole through which the rod 24 passes. The collar 94 also has plates 7 welded or otherwise secured thereto. Bolts 8 passes through the plates 7 and rotatable rod 24 before being tightened with a nut (not shown). In this manner, the collar 94 is fixedly secured to the rotatable rod 24. Other means of securing the collar 94 to the rotatable rod 24 not shown may be used without departing from the spirit of the present invention. A pair of spaced ears 98 extend rearwardly from the central portion 96. Each ear 98 has a hole 100 therein adapted to receive pin 92. The end portion 90 of the drive shaft 73 is adapted to fit between the ears 98 of the collar 94 and be secured therein by pin 92 in the manner illustrated in FIG. 1. Other mechanisms for operatively coupling the drive shaft 73 to the rotatable rod 24 may be used in accordance with the present invention.

The pneumatic cylinder 72 is powered by an air source 80 through a controller 82. The controller 82 may be mounted in a convenient location, such as the cab area of a truck, so that the driver of the vehicle can operate the pneumatic cylinder 72 by pushing a button in the cab of the vehicle. The hydraulic cylinder 72 may also be automatically actuated, such as by a sensor, for sensing a reverse movement of the vehicle and automatically activating a control switch.

Although not illustrated, the cylinder 72 may be a hydraulic cylinder rather than a pneumatic cylinder, in which case fluid would move the drive shaft rather than air.

In operation, the drive assembly 68 is initially positioned such that the mud flaps 12 are fully extended, as illustrated in FIG. 2. When the driver is ready to operate the vehicle in reverse, the driver can activate the controller 82 in the cab of the vehicle either manually or automatically to actuate the pneumatic cylinder 72. Upon activation of the pneumatic cylinder 22, the drive shaft 73 is reciprocated or moved rearwardly, thereby causing the collar 94 to rotate. Rotation of the collar 94 causes the shaft 24 to rotate. When the rod 24 rotates, the mud flap assemblies 32 simultaneously rotate about the central axis 16, thus causing the mud flaps 58 to wrap around the end plates 44,46 of the mud flap assemblies 32 in a manner shown in FIG. 3. When the mud flaps 58 are wrapped around the end plates 44, 46, they are raised to a lifted position, as illustrated in FIG. 3.

When the vehicle is switched from reverse to forward mode, the rod 24 is then rotated back to its original position, rotating the end plates 44, 46 in a reverse direction simultaneously, and thus, bringing the mud flaps 58 back to their original lowered position.

FIGS. 4-6 illustrate an alternative embodiment of mud flap lifter system 10a in accordance with the present invention. In this embodiment, for purposes of simplicity, like parts have like numbers but with an “a” designation thereafter. This embodiment of the present invention, utilizes a different drive assembly 68a than the one described above with reference to FIGS. 1-3 and 9. This drive assembly 68a comprises a hand crank manually operated by the truck's driver from outside the cab of the truck, rather than from inside the cab. Referring to FIG. 4, this drive assembly 68a has a drive shaft 73a coupled to the rotatable rod 24a in the same manner as described above. The difference between this embodiment and the embodiment described hereinabove is in how the drive shaft 73 is moved to rotate the rod.

In this preferred embodiment, a generally “L” shaped bracket 100 is secured to the outer surface 102 of the beam 18. The bracket 100 has a horizontal portion 104 and a vertical portion 106. A generally “L” shaped handle 108 is secured to the bracket 100 in the manner illustrated in FIG. 4. However, the handle 108 may be secured to the bracket 100 in other ways not illustrated. The handle 108 has a first or horizontal portion 110 and a second or vertical portion 112 extending downwardly from the outer end of the horizontal portion 110. The handle 108 is adapted to move from a first position illustrated in solid lines in FIG. 4 to a second position illustrated in dashed lines in FIG. 4.

The second or vertical portion 112 stays inside of a generally “U” shaped brace 114 which is fixedly secured to the bottom 20 of the truck bed 14, as shown in FIG. 4. The brace 114 has a horizontal portion 116 and a pair of legs 118 extending upwardly from the outer ends of the horizontal portion 116. The horizontal portion 116 of the brace 114 has a stop 120 built therein. The stop 120 may be a separate element attached to the brace 114 without departing from the spirit of the present invention. The stop 120 functions to prevent the horizontal portion 116 of the handle 108 from moving forwardly when the handle 108 is placed in its second position illustrated in dashed lines in FIG. 4.

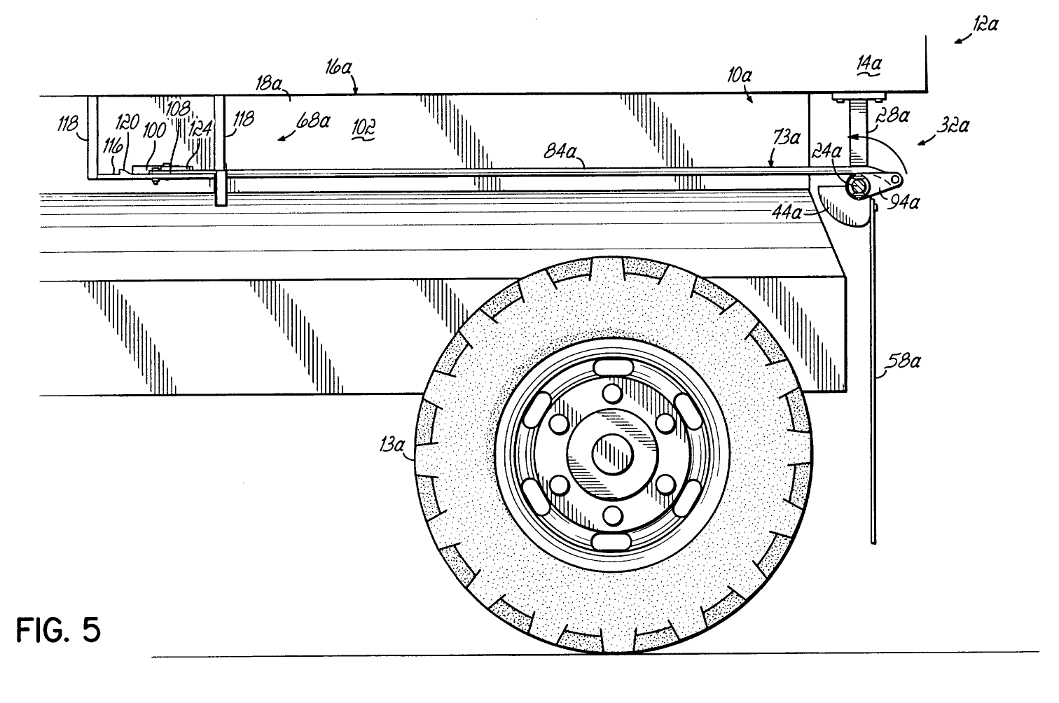

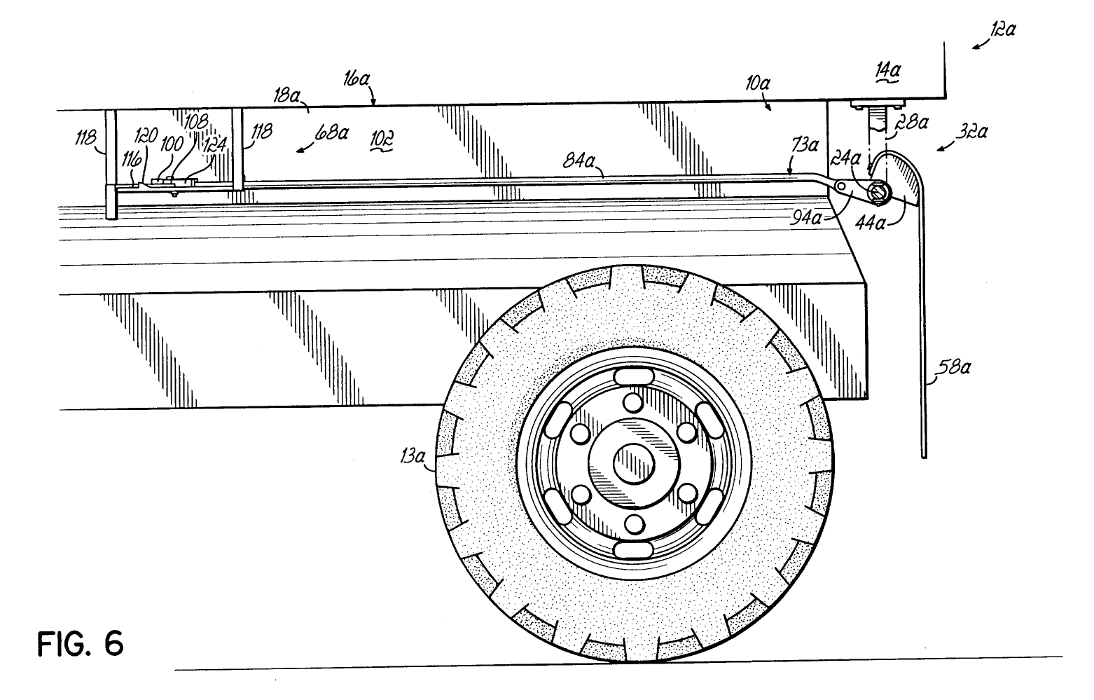

In operation, when the truck driver wishes to raise the mud flaps of this embodiment of the present invention, he or she gets out of the truck's cab and grasps the vertical portion 112 of the handle 108. The truck's driver then pulls the handle 108 forwardly in the direction of arrow 122, past the stop 120. When the driver moves the handle 108 forwardly, the drive shaft 73a is pulled forwardly due to the coupling of the handle 108 and drive shaft 73a via connector 124 shown in FIG. 8. Forward movement of the drive shaft 73a causes rotation of the rod 24a in the manner described above. Rotation of the rod 24a causes the mud flaps 58a to raise from their lowered position shown in FIG. 5 to their raised position shown in FIG. 6. The driver then gets back in the cab and drives to the desired destination.

FIG. 8 illustrates the coupling between the handle 108 and drive shaft 73a via connector 124. The connector 124 has a pair of ears 126 between which is inserted the horizontal portion 110 of the handle 108. A threaded bolt 128 passes through holes 130 in the ears 126 of the connector 124 and through a hole 132 in the horizontal portion 110 of the handle 108. Nut 134 screws onto the threaded portion of the bolt 128 to secure the handle 108 to the connector 124. Other fasteners may be used to secure the handle 108 to the connector 124.

In order to adjust the length of the drive shaft 73a, the front portion 127 of the drive shaft 73a is secured to the connector 124 in an adjustable manner. More specifically, the front portion 127 of the drive shaft 73a has threads 136 which engage threads 138 in an interior cavity 140 of the connector 124. The front end of the drive shaft 73a is designated at 142. A nut 144 is located behind the connector 124 and prevents movement of the connector 124 relative to the drive shaft 73a.

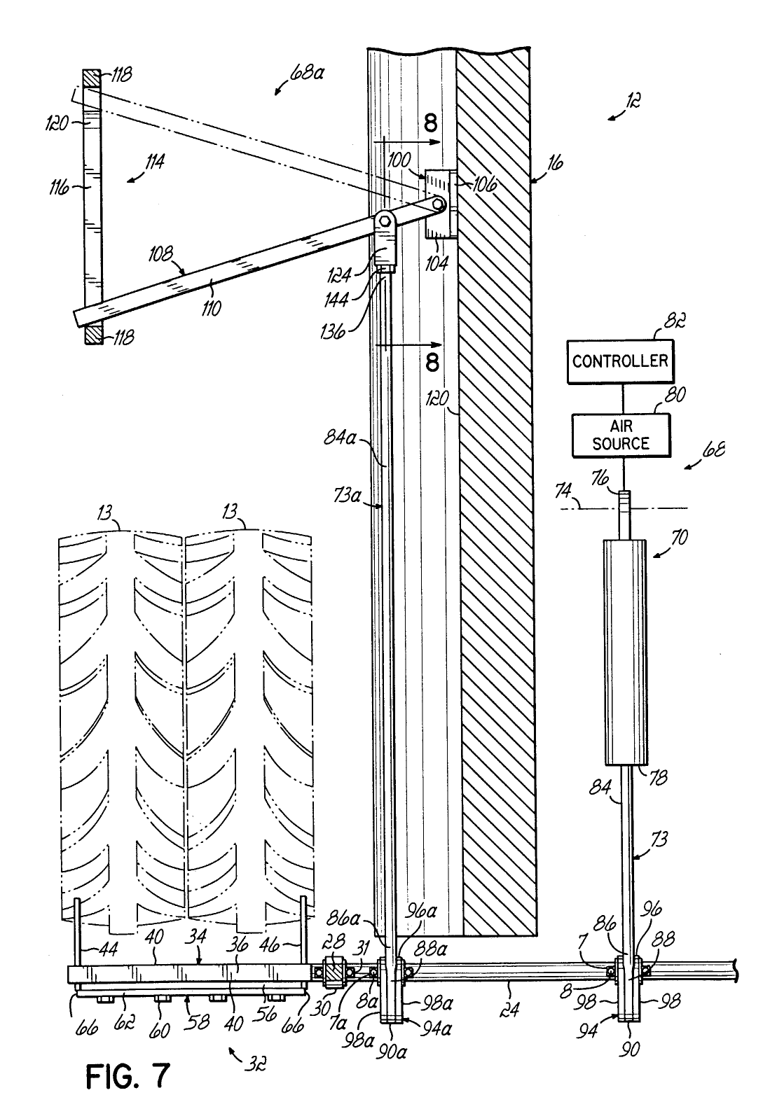

FIG. 7 illustrates an alternative embodiment of the present invention wherein a truck is equipped with both the first and second preferred embodiments of mud flap lifter systems of the present invention described above. The first mud flap lifter system 10a, powered by a hand crank, and the second mud flap lifter system 10, powered by a pneumatic or hydraulic cylinder, are both located on the truck. The operator or truck driver may use either method to lift the mud flaps 12.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of Applicant's general inventive concept.

What is claimed is:

1. A mud flap lifter system for a vehicle, the system comprising:
a rod rotatable about a central axis, the rod being coupled to the vehicle;
a mud flap coupled to the rotatable rod;
a drive shaft operatively coupled to the rotatable rod; and
means for reciprocating the drive shaft so that upon movement of the drive shaft, the rod rotates thereby lifting the mud flap.

2. The mud flap lifter system of claim 1, wherein the means for reciprocating the drive shaft is a pneumatic cylinder.

3. The mud flap lifter system of claim 1, wherein the means for reciprocating the drive shaft is a hydraulic cylinder.

4. The mud flap lifter system of claim 1, wherein the means for reciprocating the drive shaft is a hand crank.

5. The mud flap lifter system of claim 1, wherein the means for reciprocating the drive shaft is manually operated.

6. The mud flap lifter system of claim 1 wherein the mud flap is secured to a mud flap assembly, said mud flap assembly being coupled to the rotatable rod.

7. The mud flap lifter system of claim 6 wherein said mud flap assembly comprises:
a first end plate;
a second end plate spaced from said first end plate;
a flange extending between said first and second end plates said mud flap being secured to said flange.

8. A mud flap lifter system for a vehicle, the system comprising:
a rotatable rod coupled to the vehicle adapted to rotate about a central axis;
mud flap assemblies operatively coupled to the rotatable rod, each of said mud flap assemblies including a mud flap;
a drive shaft operatively coupled to rotatable rod; and
a driver for moving said drive shaft, wherein upon actuation of said driver, said drive shaft moves, causing rotation of said rotatable rod to lift and lower each of said mud flaps.

9. The mud flap lifter system of claim 8, wherein said driver is a pneumatic cylinder.

10. The mud flap lifter system of claim 8, wherein said driver is a hydraulic cylinder.

11. The mud flap lifter system of claim 8 wherein said driver is a hand crank.

12. A mud flap lifter system for a vehicle, the system comprising:
a first mud flap assembly including a first mud flap;
a second mud flap assembly including a second mud flap;
a rod rotatable about a central axis, the first and second mud flap assemblies being secured to said rod;
a drive shaft operatively coupled to said rod,
a driver operatively coupled to the drive shaft whereby upon activation of said driver said drive shaft reciprocates, thereby causing rotating of the rod about the central axis.

13. The mud flap lifter system of claim 12, wherein the driver is a pneumatic cylinder.

14. The mud flap lifter system of claim 12, wherein the driver is a hydraulic cylinder.

15. The mud flap lifter system of claim 12, wherein the driver is a hand crank.
